(19) United States
(12) Patent Application Publication
(10) Pub. No.: US 2011/0280599 A1
(43) Pub. Date: Nov. 17, 2011

(54) IMAGE FORMING APPARATUS

(75) Inventors: Koichiro Ino, Kashiwa-shi (JP); Hirokazu Kodama, Ryugasaki-shi (JP); Mitsuhiro Sugeta, Abiko-shi (JP); Takahiro Oonuma, Kashiwa-shi (JP)

(73) Assignee: CANON KABUSHIKI KAISHA, Tokyo (JP)

(21) Appl. No.: 13/107,753

(22) Filed: May 13, 2011

(30) Foreign Application Priority Data
May 17, 2010 (JP) 2010-113561
Apr. 13, 2011 (JP) 2011-089255

(51) Int. Cl. G03G 15/00; G03G 15/01

(52) U.S. Cl. 399/44; 399/49; 399/301

(57) ABSTRACT

A low density area is caused at a trailing edge of an image formed on a photosensitive drum. This low density area is less likely to be caused when the density of the image is higher and the humidity is lower. To prevent generation of such low density area, if a color misregistration detection toner pattern having a high density is formed, in a low humidity environment, an excessively large amount of toner is consumed unnecessarily. In response, the density of the color misregistration detection toner pattern is adjusted based on the humidity.

### BACKGROUND OF THE INVENTION

1. Field of the Invention

The present invention relates to an image forming apparatus such as a copying machine, a printer, or a facsimile machine that forms a color image. In particular, it relates to an image forming apparatus that forms a detection toner pattern for controlling color misregistration of toner images of individual colors.

2. Description of the Related Art

A general electro-photographic image forming apparatus, such as a copying machine or a laser beam printer, forms an image through the following process. First, a charging unit charges a surface of a photosensitive member. Next, the charged photosensitive member is exposed to a light beam. This exposure to the light beam changes charged potentials on the surface of the photosensitive member and forms an electrostatic latent image on the photosensitive member. Then, a developing unit uses toner charged with predetermined electric charges to develop the formed electrostatic latent image. The developed toner image is transferred onto a recording medium such as paper, and the toner image transferred onto the recording medium is fixed on the recording medium by a fixing device.

To improve toner developability when the developing unit develops the electrostatic latent image formed on the photosensitive member, the developing unit includes a developing sleeve, which is a developer bearing member bearing toner, and the rotation speed of the developing sleeve is set to be different from that of the photosensitive member. Because of this difference, a toner image has a lower density at the trailing edge thereof (low density area) in the rotation direction of the photosensitive member, compared with the density at the leading edge and the center portion of the toner image.

This phenomenon will be hereinafter described in more detail. As illustrated in FIGS. 11A and 11B, a magnetic brush (carrier in the form of a brush) is formed on the developing sleeve. Toner having a polarity opposite to that of the carrier is attached to the magnetic brush. To prevent a lack of toner supply, the rotation speed of the developing sleeve is controlled to be greater than that of the photosensitive member.

The above low density area will be described with reference to FIGS. 11A and 11B. For ease of description, the following description will be made, assuming that the carrier and the toner are positively and negatively charged, respectively, and the electrostatic latent image is an area that is charged positively after exposure to the light beam. When the magnetic brush is brought in proximity to the photosensitive member, the toner attached to the magnetic brush is attracted to the electrostatic latent image on the photosensitive member. In this way, the electrostatic latent image is developed by the toner (see FIG. 11A).

When the positively charged area (electrostatic latent image) on the photosensitive member continuously passes by the gap between the photosensitive member and the developing sleeve, since the negatively charged toner is attracted to the electrostatic latent image, the toner is attached to the leading edge of the magnetic brush (see FIG. 11A). Thus, carrier on the leading edge of the magnetic brush are not exposed.

On the other hand, in the rotation direction of the photosensitive member, the trailing edge of the electrostatic latent image (exposed potential area that is positively charged) borders a negatively charged potential area. Thus, as the negatively charged potential area following the exposed potential area is brought closer to the magnetic brush, the toner attached to the magnetic brush moves away from the photosensitive member (see FIG. 11B). As a result, carrier at the leading edge of the magnetic brush near the trailing edge of the electrostatic latent image are exposed. Since the rotation speed of the developing sleeve is greater than that of the photosensitive member, carrier exposed at the leading edge of the magnetic brush are sequentially brought closer to the trailing edge of the electrostatic latent image. Consequently, toner at the trailing edge of the electrostatic latent image on the photosensitive drum is pulled back to the exposed carrier, resulting in a decrease of the density at the trailing edge of the electrostatic latent image (see FIG. 11B).

The low density area is dependent on environmental conditions around the photosensitive member. As the humidity around the photosensitive member is increased, more electric charges move to the moisture around the toner. As a result, the toner charge amount is decreased. For example, the toner charge amount is greater at a humidity of 30% than at a humidity of 70%. Thus, the toner is attached more firmly to the electrostatic latent image on the photosensitive member at a humidity of 30% than at a humidity of 70%. Namely, since the toner is attached more firmly, the toner is less likely to move from the electrostatic latent image to the magnetic brush at a lower humidity, resulting in fewer low density areas.

One of the electro-photographic image forming apparatuses that uses a plurality of colors of toner to form color images is known as a tandem-type color image forming apparatus. The tandem-type color image forming apparatus includes a photosensitive member forming a toner image thereon for each of the plurality of colors of toner and transfers the toner images of the individual colors formed on the individual photosensitive members onto a recording medium to form a color image. Generally, each of the photosensitive members first transfers a toner image formed thereon onto an intermediate transfer member such as an intermediate transfer belt to superpose the toner images of the individual colors on the intermediate transfer member. Subsequently, a transfer unit transfers the toner image on the intermediate transfer member onto a recording medium.

Based on the tandem-type image forming apparatus, if the formation positions of the toner images of the individual colors transferred onto the intermediate transfer member from the individual photosensitive members are misaligned with each other on the recording medium, color misregistration is caused, resulting in a degradation of image quality. In response to this problem, Japanese Patent No. 2765626 discusses an image forming apparatus that uses color misregistration detection toner patterns to correct such color misregistration. To correct the color misregistration, this image forming apparatus forms a color misregistration detection toner pattern of each color on an intermediate transfer member and calculates a relative amount of misalignment based on the difference in the timing at which the toner patterns of the individual colors are detected. The image forming apparatus controls the timing of an exposure or the position of an optical system so that the misalignment is reduced.

A low density area as described above could be formed on the color misregistration detection toner patterns. Even if an output image includes a low density area, as long as the density is not as low as visually perceived, no problem is caused. However, as illustrated in FIG. 12, if a color misregistration detection toner pattern includes a low density area, a signal waveform obtained by detecting the low density area deviates from a desired shape (dotted line in FIG. 12). As a result, accuracy of detecting the formation position of the color misregistration detection toner pattern is decreased.

It is empirically known that the low density area is less likely to be formed as the image density is increased. Therefore, by increasing the density of the color misregistration detection toner pattern as much as possible, a decrease of detection accuracy can be controlled.

However, if two color misregistration detection toner patterns having a high density are formed under identical image forming conditions excepting one pattern formed in a low humidity environment and the other pattern formed in a high humidity environment, while a low density area is not formed in the pattern formed in a low humidity environment, a large amount of toner is consumed unnecessarily. Namely, to prevent formation of a low density area in a high humidity environment, if the image forming conditions are set so that the color misregistration detection toner patterns having a high density are formed, the color misregistration detection toner patterns having an excessively high density are formed in a low humidity environment. On the other hand, to reduce the amount of toner consumed, if the image forming conditions are set so that the color-misregistration detection toner patterns having a low density are formed regardless of the humidity, a low density area is formed in the color misregistration detection toner patterns in a high humidity environment, resulting in a decrease of detection accuracy.

### SUMMARY OF THE INVENTION

According to an aspect of the present invention, an image forming apparatus includes a plurality of image forming units each configured to form a toner image on an image bearing member, a detection unit configured to detect a positional relationship of the toner images formed on the image bearing member by the plurality of image forming units, and a control unit configured to cause the plurality of image forming units to form a detection toner pattern on the image bearing member to detect the positional relationship. The control unit controls formation conditions of the detection toner pattern based on humidity. In addition, the control unit causes the image forming units to form the detection toner pattern under different formation conditions between a first humidity and a second humidity lower than the first humidity, so that the density of the detection toner pattern formed at the first humidity is higher than the density of the detection toner pattern formed at the second humidity.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a cross section of an image forming apparatus according to an exemplary embodiment of the present invention.

FIG. 2 is a schematic diagram illustrating an optical scanning device and a photosensitive drum.

FIG. 3 is a schematic diagram illustrating color misregistration correction toner patterns formed on an intermediate transfer belt.

FIG. 4 is a control block diagram of the image forming apparatus according to the exemplary embodiment of the present invention.

FIG. 5 is a flow chart of color misregistration correction control executed by the image forming apparatus according to the exemplary embodiment of the present invention.

FIG. 6 is a schematic diagram illustrating an optical sensor included in the image forming apparatus.

FIG. 7 illustrates a waveform of an analog signal output from the optical sensor and a waveform of a digital signal generated from the analog signal.

FIGS. 8A and 8B illustrate density distributions of detection toner patterns.

FIG. 9A illustrates a detection toner pattern and FIGS. 9B to 9D illustrate pulse width modulation (PWM) signals each for forming a detection toner pattern.

FIG. 10 is a control block diagram of a variation of the image forming apparatus according to the exemplary embodiment of the present invention.

FIGS. 11A and 11B are schematic cross sections of a developing sleeve and a photosensitive drum and are used to describe a low density area.

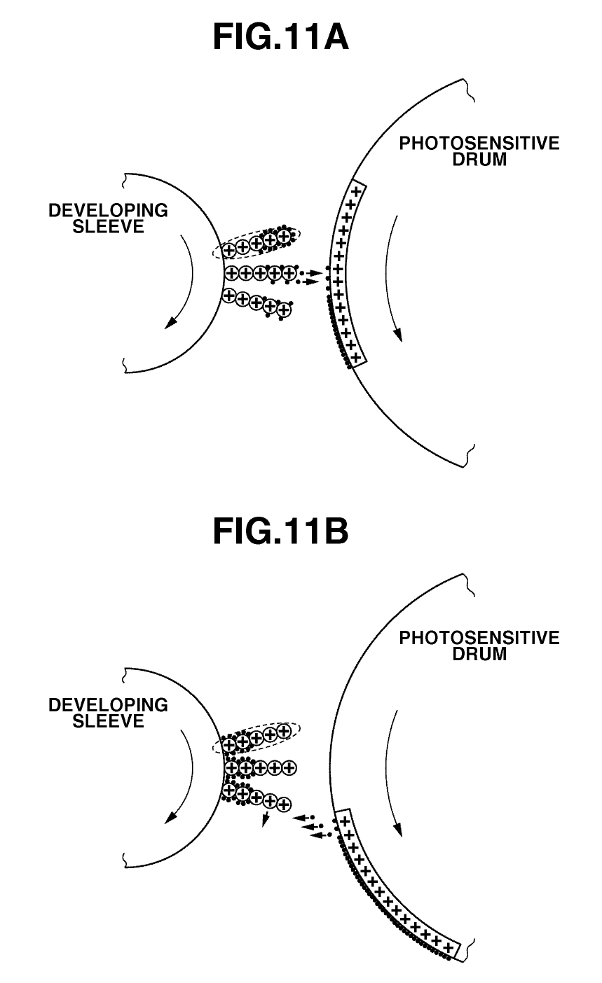

FIG. 12 illustrates detection results of a color misregistration detection toner pattern including a low density area.

### DESCRIPTION OF THE EMBODIMENTS

Various exemplary embodiments, features, and aspects of the invention will be described in detail below with reference to the drawings. However, the scope of the present invention is not limited to dimensions, materials, and shapes of components described in the exemplary embodiments or to the relative arrangement of the components, unless otherwise specified.

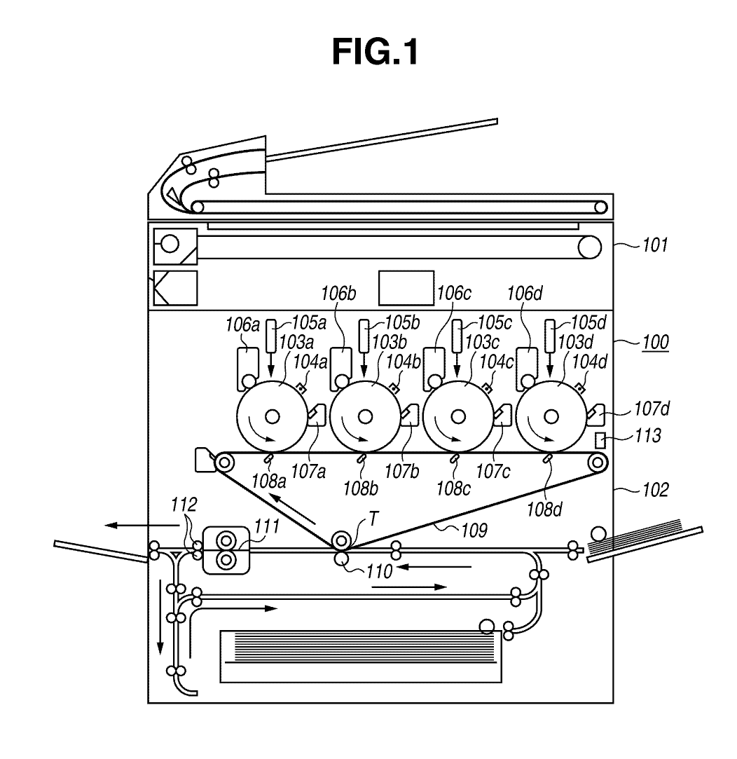

FIG. 1 is a cross section of an overall configuration of an image forming apparatus 100 according to an exemplary embodiment. More specifically, FIG. 1 is a cross section of a schematic configuration of an electro-photographic full-color printer. The image forming apparatus 100 illustrated in FIG. 1 includes a document reading section 101 and an image forming section 102. The document reading section 101 reads a document image, and the image forming section 102 forms an image on a recording medium based on read image data.

The image forming section 102 includes: an image forming unit Y forming yellow (Y) toner images; an image forming unit M forming magenta (M) toner images; an image forming unit C forming cyan (C) toner images; and an image forming unit Bk forming black (Bk) toner images. The image forming unit Y includes: a photosensitive drum 103a, which is a photosensitive member; a charging device 104a charging the photosensitive drum 103a; and an optical scanning device 105a emitting alight beam (laser beam) to form an electrostatic latent image on the charged photosensitive drum 103a. In addition, the image forming unit Y further includes: a developing device 106a developing the electrostatic latent image formed on the photosensitive drum 103a with toner; and a cleaning device 107a cleaning the photosensitive drum 103a having residual toner thereon.

Likewise, the other image forming units M, C, and Bk have a configuration similar to that of the image forming unit Y. The image forming unit M forming magenta toner images includes: a photosensitive drum 103b (a first image bearing member), which is a photosensitive member; a charging device 104b; an optical scanning device 105b; a developing device 106b; and a cleaning device 107b. The image forming unit C forming cyan toner images includes: a photosensitive drum 103c, which is a photosensitive member; a charging device 104c; an optical scanning device 105c; a developing device 106c; and a cleaning device 107c. The image forming unit Bk forming black toner images includes: a photosensitive drum 103d (a second image bearing member), which is a photosensitive member; a charging device 104d; an optical scanning device 105d; a developing device 106d; and a cleaning device 107d.

Next, an image formation process executed by each of the image forming units Y, M, C, and Bk will be described. Since all the image forming units Y, M, C, and Bk execute an identical image formation process, a process executed by the image forming unit Y will be described as an example. First, the charging device 104a charges the photosensitive drum 103a. The optical scanning device 105a includes a laser emitting unit as a light source, and this laser emitting unit emits laser beams (light beams) to the charged photosensitive drum 103a to form an electrostatic latent image on the charged photosensitive drum 103a. The developing device 106a develops the electrostatic latent image with a developer including yellow toner and carrier which charges the yellow toner. Next, the yellow toner image developed on the photosensitive drum 103a is transferred onto an intermediate transfer belt 109, which is an intermediate transfer member (image bearing member), by a transfer bias applied to a transfer blade 108a.

Likewise, magenta, cyan, and black toner images on the photosensitive drums 103b, 103c, and 103d are transferred onto the intermediate transfer belt 109 (an image bearing member) by transfer blades 108b, 108c, and 108d, respectively. A secondary transfer roller 110 collectively transfers the toner images of the four colors transferred onto the intermediate transfer belt 109 onto a recording sheet at a secondary transfer section T. Next, a recording medium S bearing the toner image passes through a fixing device 111, which executes a fixing process on the recording medium S. Finally, a discharge roller 112 and the like discharge the recording medium S to the outside of the image forming apparatus 100.

The image forming unit Bk is arranged to be closer to the secondary transfer section T than the other chromatic color image forming units Y, M, and C in the rotation direction of the intermediate transfer belt 109. With this arrangement, the time required from when a user instructs the image forming apparatus 100 to form a monochrome image to when the image forming apparatus 100 outputs an image can be shortened.

An optical sensor 113 detecting a color misregistration detection toner pattern, which is described later, is arranged near the intermediate transfer belt 109. As illustrated in FIG. 1, the optical sensor 113 is arranged to face the intermediate transfer belt 109 which is between the image forming unit Bk forming black toner images and the secondary transfer roller 110.

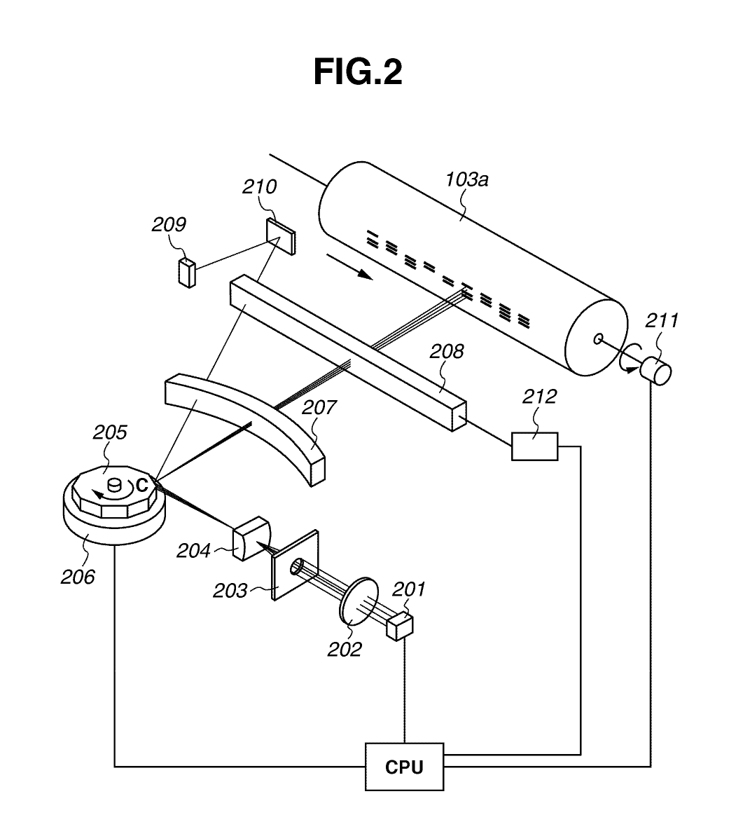

FIG. 2 is a schematic diagram illustrating an internal configuration of the optical scanning device 105a and the photosensitive drum 103a. Since the optical scanning devices 105a to 105d have an identical configuration, the optical scanning device 105a will be described as an example. The optical scanning device 105a includes: a semiconductor laser 201, which is a light source; a collimator lens 202; an aperture stop 203; a cylindrical lens 204; a polygonal mirror 205; a polygonal mirror drive unit 206; a toric lens 207; and a diffractive optical element 208.

The collimator lens 202 converts the light beams emitted from the semiconductor laser 201 into parallel light fluxes. The aperture stop 203 limits incident laser beam fluxes. The cylindrical lens 204 has a predetermined refractive power only in the sub-scanning direction and uses light fluxes that have passed through the aperture stop 203 to form an elliptical image that is long in the main scanning direction on a reflection surface of the polygonal mirror 205. The polygonal mirror drive unit 206 rotates the polygonal mirror 205, which is a rotating polygonal mirror, at constant speed in the direction of an arrow C in FIG. 2. The polygonal mirror 205 deflects the laser beams formed on the reflection surface and executes a scanning operation.

The toric lens 207 is an optical element having fθ characteristics and has a different refractive index between the main scanning direction and the sub-scanning direction. The toric lens 207 has aspheric front and back surfaces in the main scanning direction. The diffractive optical element 208 is an optical element having fθ characteristics and has a different magnification between the main scanning direction and the sub-scanning direction. A beam detector (BD) 209, which is a laser beam detection unit, is arranged at a position outside the image formation area on the photosensitive drum 103a included in the image forming apparatus 100. The BD 209 detects laser beams reflected by the reflection mirror 210 and generates a scanning timing signal (BD signal).

Spots of the laser beams emitted from the semiconductor laser 201 and deflected by the rotated polygonal mirror 205 are linearly moved on the photosensitive drum 103a in parallel to the photosensitive drum shaft (main scanning). The optical scanning device 105a according to the present exemplary embodiment uses a multi-beam laser emitting a plurality of beams as the semiconductor laser 201. Thus, the optical scanning device 105a can form a plurality of linear electrostatic latent images in a single scanning operation. A drum drive unit 211 rotates the photosensitive drum 103a. By repeating the main scanning operation on the photosensitive drum 103a with the light beams, the optical scanning device 105a writes an image on the rotating photosensitive drum 103a in the sub-scanning direction (rotation direction of the photosensitive drum 103a).

A diffractive optical element drive unit 212 can rotate the diffractive optical element 208 about an axis parallel to an incident optical axis. By rotating the diffractive optical element 208 about this axis, the optical scanning device 105a can correct an orientation of the scanning lines on the photosensitive drum 103a (the inclination angles of the scanning lines with respect to the rotation shaft of the photosensitive drum 103a). In addition, the diffractive optical element drive unit 212 can rotate the diffractive optical element 208 about an axis parallel to a longitudinal direction of the diffractive optical element 208. By rotating the diffractive optical element 208 about this axis, the optical scanning device 105a can correct a curvature of the scanning lines on the photosensitive drum 103a.

A central processing unit (CPU) 401, which will be described later, controls the semiconductor laser 201, the polygonal mirror drive unit 206, the drum drive unit 211, and the diffractive optical element drive unit 212. After the charging device 104a charges the surface of the photosensitive drum 103a, the laser beams expose the surface of the charged photosensitive drum 103a. Potentials on the surface of the photosensitive drum 103a change depending on an intensity of the emitted laser beams.

Next, relative misalignment (color misregistration) caused by the toner images of the individual colors transferred onto the intermediate transfer belt 109 by the individual image forming units Y, M, C, and Bk (first and second image forming units) will be described. As described above, yellow, magenta, cyan, and black toner images are formed on the photosensitive drums 103a to 103d, respectively. By transferring these toner images formed on the photosensitive drums 103a to 103d onto a recording medium, a color image is formed on the recording medium. If the toner images formed on the photosensitive drums 103a to 103d are superposed on the recording medium and misalignment is caused, a tint variation is caused between the document image and the output image, resulting in a decrease of its image quality.

The image forming apparatus 100 uses toner of the individual colors and forms a color misregistration detection toner pattern on the intermediate transfer belt 109 at a predetermined timing, such as when the power source is turned on and is returned from a standby state or when images are formed on a predetermined number (cumulative number) of sheets of a recording medium. The image forming apparatus 100 causes the optical sensor 113 to detect the color misregistration detection toner pattern, and based on the detection results, the image forming apparatus 100 calculates a relative misalignment of the toner images of the individual colors and executes control to reduce the misalignment.

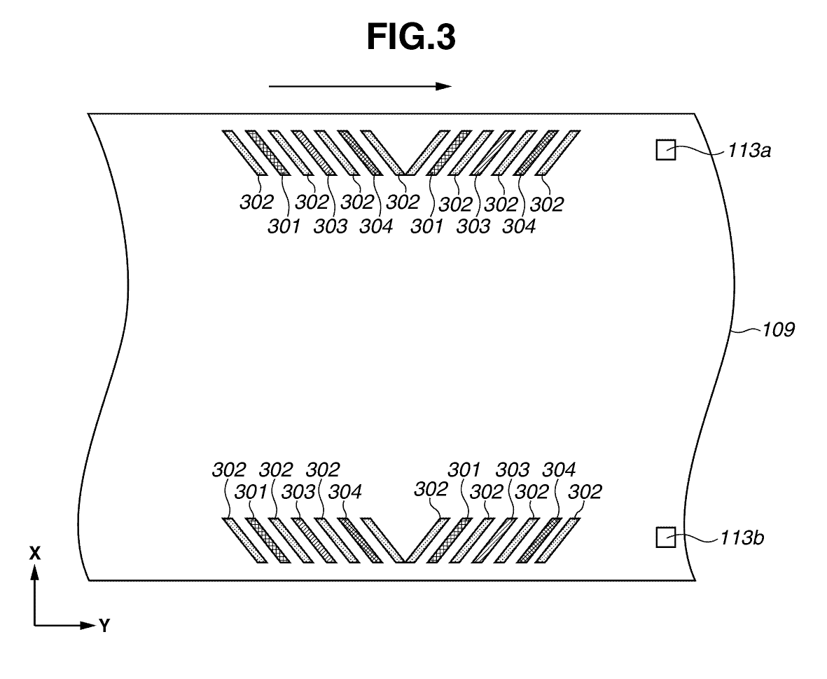

FIG. 3 is a schematic diagram illustrating color misregistration detection toner patterns formed on the intermediate transfer belt 109. FIG. 3 illustrates yellow, magenta, cyan, and black toner patterns 301, 302, 303, and 304, respectively, transferred onto the intermediate transfer belt 109 from the corresponding photosensitive drums 103a to 103d of the individual colors. Hereinafter, these yellow, magenta, cyan, and black toner patterns 301, 302, 303, and 304 will be collectively referred to as a color misregistration detection toner pattern.

In FIG. 3, the X-axis (main scanning direction) is parallel to the rotation shaft of each of the photosensitive drums 103a to 103d. The intermediate transfer belt 109 is conveyed along the Y-axis (sub-scanning direction) perpendicular to the X-axis. For example, two color misregistration detection toner patterns are formed in the main scanning direction. A plurality of optical sensors 113 (optical sensors 113a and 113b) are arranged, each of which detects a corresponding one of the color misregistration detection toner patterns formed at different positions in the main scanning direction in FIG. 3.

The image forming apparatus 100 according to the present exemplary embodiment calculates a relative misregistration amount of the toner pattern formation positions of other colors including black, other than magenta, with respect to the magenta toner pattern 302 used as a reference color. Further, when executing image formation based on input image data, the image forming apparatus 100 executes correction control so that color misregistration of the toner images of the individual colors is not caused.

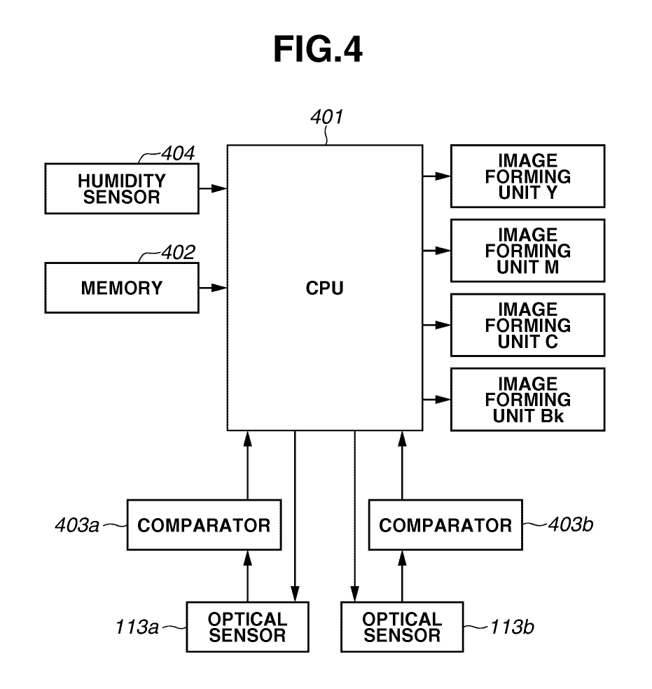

FIG. 4 is a control block diagram illustrating a configuration for color misregistration correction control of the image forming apparatus 100 according to the present exemplary embodiment. The central processing unit (CPU) 401 executes the color misregistration correction. The CPU 401 also functions as a light quantity control unit controlling light quantity (intensity) of the light beams (laser beams) emitted from the semiconductor laser 201 and as a signal generation unit controlling a pulse width modulation (PWM) signal pulse width described later in detail.

The memory 402 stores a control flow for the color misregistration correction control. Comparators 403a and 403b receive an analog signal from the optical sensors 113a and 113b and convert the analog signal into a digital signal, respectively, which will be described in detail later. Hereinafter, for ease of description, the optical sensors 113a and 113b will be referred to as the optical sensor 113 and the comparators 403a and 403b as the comparator 403.

The comparator 403 outputs the digital signal to the CPU 401. Based on the input digital signal, the CPU 401 detects a relative positional relationship of the misregistration detection toner patterns of the individual colors, and based on the detection results, the CPU 401 calculates a relative misalignment amount of the color misregistration detection toner patterns of the individual colors. Next, based on the misalignment amount, the CPU 401 executes the color misregistration correction control. The CPU 401 sends a signal for correcting the color misregistration to each of the image forming units Y, M, C, and Bk.

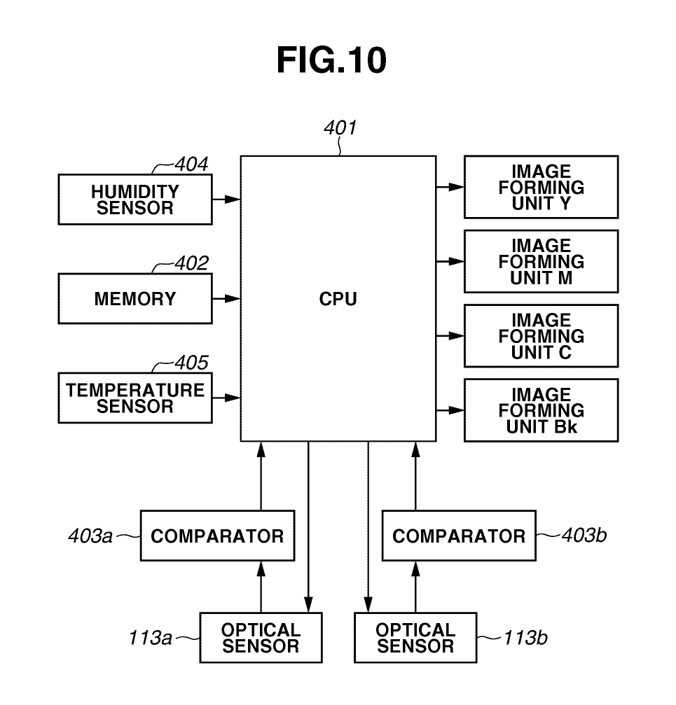

In addition, the image forming apparatus 100 according to the present exemplary embodiment includes a humidity sensor 404 (a humidity detection unit) as a unit for detecting environmental conditions. The humidity sensor 404 is arranged near each of the photosensitive drums 103a to 103d of the image forming units and detects a fluctuation of relative humidity near the photosensitive drums 103a to 103d. Alternatively, the humidity sensor 404 may be arranged for at least one image forming unit, instead of for all of the image forming units. Alternatively, the humidity sensor 404 may be arranged for the image forming apparatus 100 instead of for at least one image forming unit or for all of the image forming units. Alternatively, the image forming apparatus 100 obtains the formation condition information (e.g. date) with respect to the humidity from the information apparatus which is disposed outside of the image forming apparatus 100. According to the present exemplary embodiment, the image forming apparatus 100 includes at least one humidity sensor 404 as an environmental sensor. However, as illustrated in FIG. 10, the image forming apparatus 100 according to the exemplary embodiment may include both the humidity sensor 404 and a temperature sensor 405 (a temperature detection unit) as environmental sensors. Based on the image forming apparatus 100 including only the humidity sensor 404, the CPU 401 controls a density of the color misregistration detection toner patterns based on the relative humidity detected by the humidity sensor 404. If the image forming apparatus 100 includes both the humidity sensor 404 and the temperature sensor 405, the CPU 401 calculates the absolute humidity (moisture content per unit volume) based on results detected by the humidity sensor 404 and the temperature sensor 405, and based on the absolute humidity, the CPU 401 controls the density of the color misregistration detection toner patterns as described below.

The optical sensor 113 detecting color misregistration detection toner patterns can detect reflected light as regular reflection light or irregular reflection light (diffuse reflection light). The image forming apparatus 100 according to the present exemplary embodiment adopts the optical sensor 113 detecting the irregular reflection light.

Use of the image forming apparatus 100 over a long period of time affects the toner or the cleaning devices 107a to 107d, resulting in a decrease in the glossiness of the surface of the intermediate transfer belt 109. If the optical sensor 113 detecting the regular reflection light is used, the detection results are more subject to change of the surface conditions of the intermediate transfer belt 109. Thus, to ensure detection accuracy in view of change of the surface conditions, the image forming apparatus 100 needs to execute correction control, such as control of the emission light quantity or adjustment of the toner pattern density. If the optical sensor 113 detecting the irregular reflection light is used, the frequency of such correction control can be reduced.

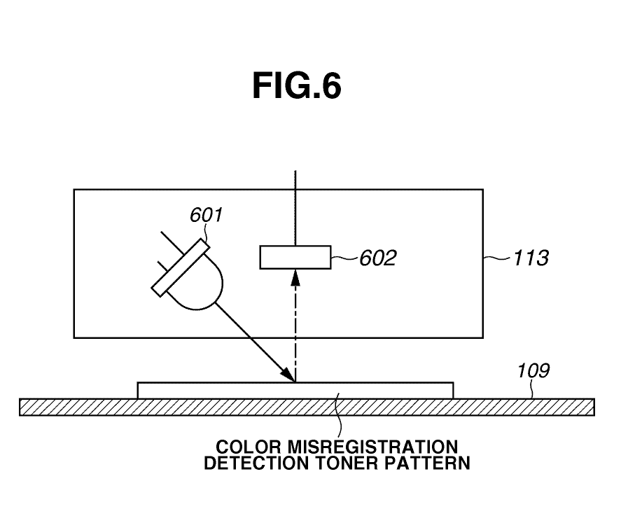

FIG. 6 is a schematic diagram of the optical sensor 113. The optical sensor 113 includes: a light emitting unit 601 emitting light to the intermediate transfer belt 109 or the color misregistration detection toner patterns; and a light receiving unit 602 receiving reflected light from the intermediate transfer belt 109 or the color misregistration detection toner patterns. The light receiving unit 602 is arranged to receive the irregular reflection light of the light emitted from the light emitting unit 601 to the intermediate transfer belt 109 at a position where an incident angle and a reflection angle of the light are not identical.

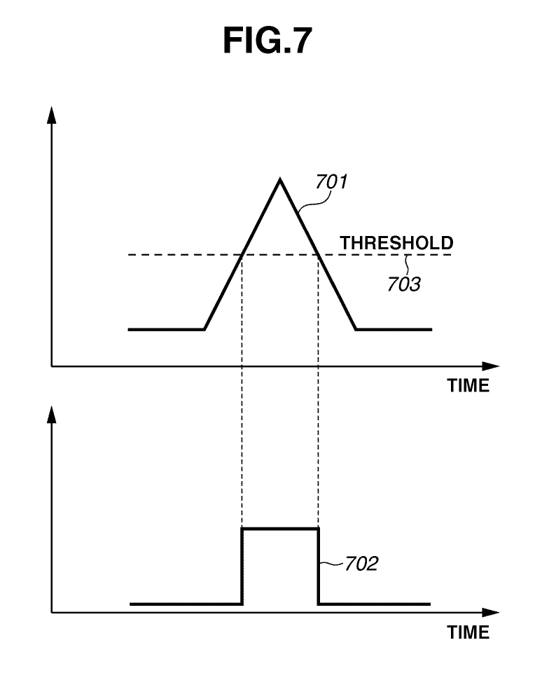

FIG. 7 illustrates an analog signal 701 (a detected signal) obtained when the optical sensor 113 detects a color misregistration detection toner pattern and a digital signal 702 generated from the analog signal 701. Since the intermediate transfer belt 109 has a glossy surface, the quantity of the regular reflection light reflected by the surface of the intermediate transfer belt 109 is larger than that reflected by a toner pattern having a chromatic color. Since the light emitting unit 601 emits light with a constant light quantity, the quantity of the irregular reflection light reflected by the surface of the intermediate transfer belt 109 is smaller than that reflected by the toner pattern having the chromatic color. Thus, as illustrated in FIG. 7, the analog signal 701, which is obtained when the optical sensor 113 detects the toner pattern of the chromatic color, exhibits a waveform having an upwardly protruded portion. While the analog signal 701 illustrated in FIG. 7 exhibits a triangular waveform, the analog signal 701 may exhibit a waveform of another shape. The waveform is dependent on the width of a toner pattern in the rotation direction (drive direction) of the intermediate transfer belt 109 and on the width of the light receiving unit 602 of the optical sensor 113. Thus, depending on these widths, a trapezoidally-shaped wave may be detected.

The digital signal 702 is obtained by binarizing the analog signal 701 output from the light receiving unit 602. If the comparator 403 receives an analog signal of an output level equal to or greater than a threshold 703, the comparator 403 outputs a high-level digital signal. If the comparator 403 receives an analog signal of an output level less than the threshold 703, the comparator 403 outputs a low-level digital signal.

The CPU 401 detects a center position, a rising edge timing, or a falling edge timing of an output waveform of the digital signal 702 illustrated in FIG. 7, and based on the detection results, the CPU 401 executes the color misregistration correction control. An exemplary embodiment where the CPU 401 executes the color misregistration correction control by detecting the center position of the output waveform will be described below.

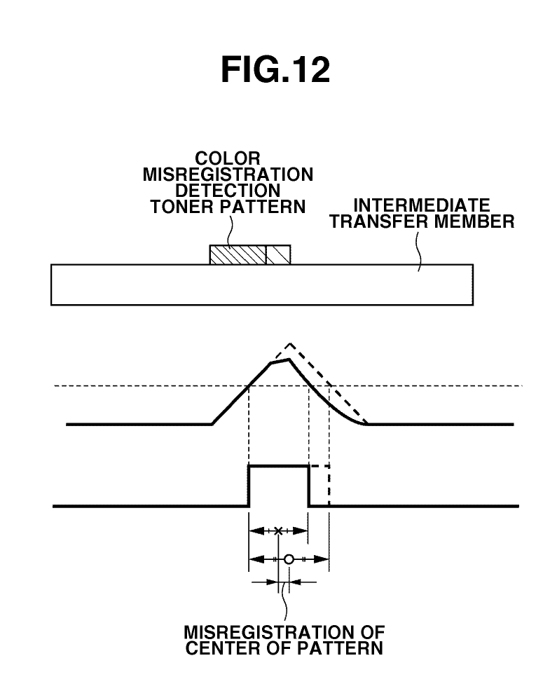

The width of a low density area varies depending on the toner images of the individual colors and on the humidity. Thus, if the humidity changes and a low density area is caused, detection accuracy of the center position of an output waveform of the digital signal is decreased, as illustrated in FIG. 12. Thus, the color misregistration detection toner patterns formed by the image forming apparatus 100 according to the present exemplary embodiment are adjusted to have such density that does not form a low density area at the trailing edge of an image based on detection results of the humidity sensor 404.

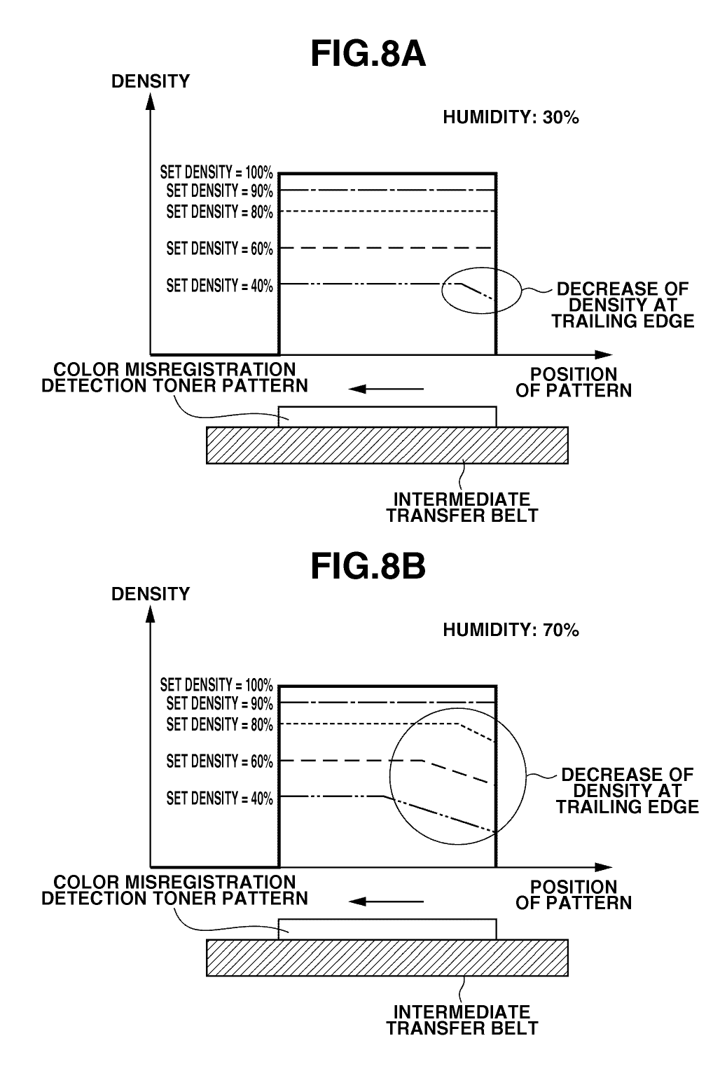

FIG. 8A is a graph illustrating a density distribution of the detection toner patterns formed on the intermediate transfer belt 109. In the graphs of FIGS. 8A and 8B, the horizontal axis represents the detection toner pattern formation position and the vertical axis represents a density (amount of toner loaded). As illustrated in FIGS. 8A and 8B, the detection toner patterns are conveyed in the direction of the arrow. As illustrated in FIGS. 8A and 8B, the CPU 401 controls the pulse width of the PWM signal driving the semiconductor laser 201 or the light quantity of the laser beams emitted from the semiconductor laser 201, so that, when the humidity around the photosensitive drum 103 detected by the humidity sensor 404 is 30% (second humidity), color misregistration detection toner patterns are formed at set density 60%.

On the other hand, the CPU 401 controls the pulse width of the PWM signal driving the semiconductor laser 201 or the light quantity of the laser beams emitted from the semiconductor laser 201, so that, when the humidity around the photosensitive drum 103 detected by the humidity sensor 404 is 70% (first humidity), color misregistration detection toner patterns are formed at set density 90%.

Namely, the CPU 401 controls the semiconductor laser 201 included in each of the image forming units, so that the density (first density) of the color misregistration detection toner patterns formed when the humidity is 70% is higher than the density (second density) of the color misregistration detection toner patterns formed when the humidity is 30%. During this operation, the CPU 401 functions as a pulse width control unit or a light quantity control unit.

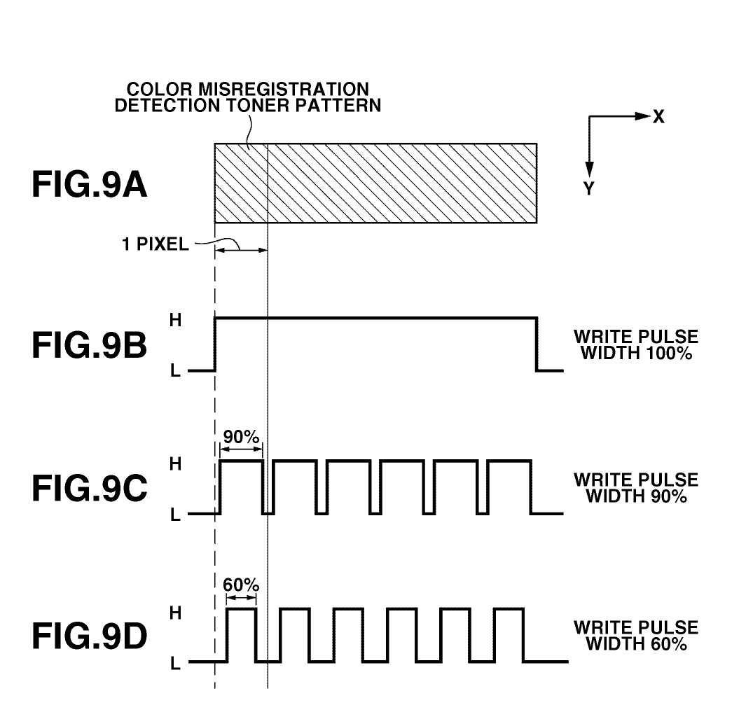

When forming color misregistration detection toner patterns, the image forming apparatus 100 according to the present exemplary embodiment adjusts a density of the color misregistration detection toner patterns by changing the exposure area per pixel. FIG. 9A illustrates a detection toner pattern and FIGS. 9B to 9D illustrate PWM signals each for forming a detection toner pattern. Each of the driving signals (PWM signals) drives a corresponding one of the semiconductor lasers 201 included in the image forming units. FIG. 9A schematically illustrates a color misregistration detection toner pattern. In FIG. 9A, the X-axis represents the main scanning direction and Y-axis represents the sub-scanning direction. The PWM signal waveform in FIG. 9B represents a driving signal pulse width used to expose a single pixel as a whole. In FIG. 9B, the pulse width is 100%.

The PWM signal in FIG. 9C represents a driving signal pulse width supplied to the semiconductor laser 201 to form a color misregistration detection toner pattern when the humidity detected by the humidity sensor 404 is 70%. In FIG. 9C, the pulse width is adjusted to 90%. Along with an increase in the pulse width of the driving signal, the exposure area per pixel (unit area) is increased, and the amount of toner adhered within a single pixel is also increased. The PWM signal in FIG. 9D represents a driving signal pulse width supplied to the semiconductor laser 201 to form a color misregistration detection toner pattern when the humidity detected by the humidity sensor 404 is 30%. In FIG. 9D, the pulse width is adjusted to 60%.

The CPU 401 can adjust the density of a color misregistration detection toner pattern by controlling the PWM signal pulse width or controlling the light quantity (intensity) of the semiconductor laser 201. In the latter case, the CPU 401 controls the semiconductor laser 201, so that the intensity of the laser beams emitted from the semiconductor laser 201 to form a color misregistration detection toner pattern when the humidity detected by the humidity sensor 404 is 70% is larger than that emitted from the semiconductor laser 201 to form a color misregistration detection toner pattern when the humidity is 30%.

As described above, if the humidity is increased, the toner charge amount is decreased. Under the identical image forming conditions, if two toner images are formed in different humidity environments, one in a high humidity environment and the other in a low humidity environment, the toner image formed in a high humidity environment has a lower density compared with the toner image formed in the low humidity environment. The color misregistration detection patterns exhibit a similar behavior. Namely, if toner images are formed under the identical image forming conditions, the color misregistration detection toner patterns formed in a high humidity environment have a lower density, compared with those formed in a low humidity environment. As described above, when the color misregistration detection toner patterns are formed under identical conditions, low density areas are formed. Thus, the image forming apparatus 100 according to the present exemplary embodiment increases the density of the color misregistration detection toner patterns along with an increase in humidity. In addition, the image forming apparatus 100 changes the image forming conditions to form the color misregistration detection toner patterns having such density that does not form low density areas in a high humidity environment.

As described above, by controlling the density of the color misregistration detection toner patterns based on the detection results of the ambient humidity of the photosensitive drum, generation of low density areas can be prevented. Thus, a decrease of accuracy of the color misregistration correction control can be prevented.

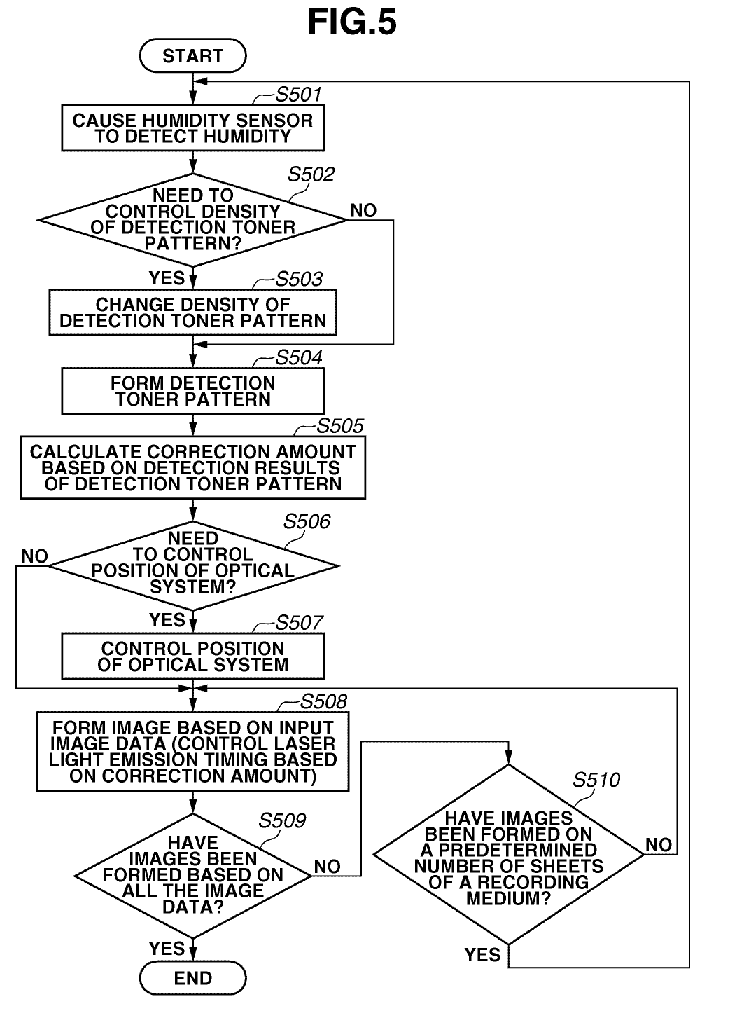

FIG. 5 is a control flow chart of an operation executed by the CPU 401 during image formation. The CPU 401 controls (changes) the density of the color misregistration detection toner patterns based on detection results of the humidity, when the power source of the image forming apparatus is turned on, when image data is input from a reading unit or an external information apparatus during a standby state, or when the humidity fluctuates and reaches to a predetermined value or more during continuous image formation. In addition, the CPU 401 executes the color misregistration correction control, when the power source of the image forming apparatus is turned on, when image data is input from a reading unit or an external information apparatus during a standby state, or when images have been formed on a predetermined number of sheets of a recording medium during continuous image formation. FIG. 5 is a flow chart of the color misregistration detection toner pattern density control and the color misregistration correction control executed by the CPU 401 from when image data is input in a standby state to when image formation is completed.

First, in step S501, the CPU 401 receives humidity information from the humidity sensor 404. Next, in step S502, the CPU 401 determines whether the density of the detection toner patterns needs to be changed. If the CPU 401 determines that the density of the color misregistration detection toner patterns needs to be changed (YES in step S502), in step S503, the CPU 401 changes data about the color misregistration detection toner pattern set density stored in the memory 402. When forming color misregistration detection toner patterns, the CPU 401 reads the data about the set density from the memory 402 and controls the image forming units, so that the color misregistration detection toner patterns are formed based on the set density.

After changing the density of the color misregistration detection toner patterns in step S503, in step S504, the CPU 401 controls each of the image forming units to form a color misregistration detection toner pattern. If the CPU 401 determines that the density of the color misregistration detection toner patterns does not need to be changed in step S502, the CPU 401 skips step S503 and proceeds to step S504.

Next, in step S505, the CPU 401 calculates a correction amount, based on an output from the optical sensor 113 that has detected color misregistration detection toner patterns. Next, in step S506, the CPU 401 determines whether the position of an optical system such as a lens and a reflection mirror (the diffractive optical element 208 in the present exemplary embodiment) included in each of the optical scanning devices 105a to 105d needs to be controlled (changed). If the CPU 401 determines that the position of the optical system needs to be changed (YES in step S506), in step S507, the CPU 401 controls the position of the optical system. After controlling the position, in step S508, the CPU 401 causes each of the image forming units to form an image, based on the correction amount calculated in step S505. If the CPU 401 determines that the position of the optical system does not need to be changed (NO in step S506), the CPU 401 skips step S507 and proceeds to step S508.

Next, in step S509, each time images have been formed on a single sheet of recording medium, the CPU 401 determines whether the images have been formed based on all the image data. If the CPU 401 determines that the images have been formed based on all the image data (YES in step S509), the CPU 401 ends the image formation. If the CPU 401 determines that the images have not been formed based on all the image data (NO in step S509), in step S510, the CPU 401 determines whether the images have been formed on a predetermined number (cumulative number) of sheets of a recording medium. If the CPU 401 determines that the images have been formed on the predetermined number (cumulative number) of sheets of a recording medium (YES in step S510), the CPU 401 returns to step S501. However, if the CPU 401 determines that the images have not been formed on the predetermined number (cumulative number) of sheets of a recording medium (NO in step S510), the CPU 401 returns to step S508.

As described above, by controlling the density of the color misregistration detection toner patterns based on the detection results of the ambient humidity of the photosensitive drum, generation of low density areas can be controlled. Thus, a decrease of accuracy of the color misregistration correction control can be prevented. In addition, compared with an image forming apparatus forming color misregistration detection toner patterns at a certain high density (for example, the highest density that can be output from the image forming apparatus), since the image forming apparatus 100 according to the present exemplary embodiment can change the density of the color misregistration detection toner patterns depending on the humidity, the amount of toner consumed can be reduced. Additionally, when the humidity is low, the image forming apparatus 100 uses a smaller amount of toner to form color misregistration detection toner patterns. Thus, burden on the cleaning devices 107a to 107d can be reduced.

While the image forming apparatus 100 according to the present exemplary embodiment adjusts the density of the detection toner patterns depending on the detection results from the humidity sensor, the image forming apparatus 100 controls the density of the images formed based on input image data to be constant based on the detection results from the humidity sensor. Namely, while the image forming apparatus 100 according to the present exemplary embodiment changes the density of the detection toner patterns based on detection results from the humidity sensor, the image forming apparatus 100 controls images formed based on input image data to be constant based on the detection results from the humidity sensor.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2010-113561 filed May 17, 2010 and No. 2011-089255 filed Apr. 13, 2011, which are hereby incorporated by reference herein in their entirety.

What is claimed is:

1. An image forming apparatus comprising:
a plurality of image forming units each configured to form a toner image on an image bearing member;
a detection unit configured to detect a positional relationship of the toner images formed on the image bearing member by the plurality of image forming units; and
a control unit configured to cause each of the plurality of image forming units to form a detection toner pattern on the image bearing member to detect the positional relationship,
wherein the control unit causes the image forming units to form the detection toner pattern under different formation conditions on a first humidity or a second humidity lower than the first humidity in such a manner that a density of the detection toner pattern formed at the first humidity is higher than a density of the detection toner pattern formed at the second humidity.

2. The image forming apparatus according to claim 1,
wherein each of the image forming units comprises a light source configured to emit a light beam to a photosensitive member based on image data to form the detection toner pattern on the image bearing member, and
wherein the control unit controls emission time of the light beam from the light source in such a manner that the emission time of the light beam to form the detection toner pattern at the first humidity is longer than the emission time of the light beam to form the detection toner pattern at the second humidity.

3. The image forming apparatus according to claim 1,
wherein each of the image forming units comprises a light source configured to emit a light beam to a photosensitive member based on image data to form the detection toner pattern on the image bearing member, and
wherein the control unit controls light quantity of the light beam in such a manner that the light quantity of the light beam to form the detection toner pattern at the first humidity is larger than an emission time of the light beam to form the detection toner pattern at the second humidity.

4. The image forming apparatus according to claim 1,
wherein each of the image forming units comprises a developing unit configured to form a toner image on the image bearing member with a developer including toner and carrier which charges the toner.

5. The image forming apparatus according to claim 1, further comprising:
a humidity detection unit configured to detect the humidity,
wherein the humidity detection unit detects a relative humidity.

6. The image forming apparatus according to claim 5, further comprising:
a temperature detection unit,
wherein the control unit calculates a moisture content per unit volume based on a relative humidity detected by the humidity detection unit and a temperature detected by the temperature detection unit, and
wherein the control unit causes the image forming units to form the detection toner pattern under different formation conditions on a first moisture content or a second moisture content lower than the first moisture content in such a manner that the density of the detection toner pattern formed at the first moisture content is higher than the density of the detection toner pattern formed at the second moisture content.

7. The image forming apparatus according to claim 1, further comprising:
at least one humidity detection unit configured to detect the humidity,
wherein, based on a detection result of the humidity detection unit, the control unit causes the image forming units to form the detection toner pattern under different formation conditions on the first humidity or the second humidity.

8. The image forming apparatus according to claim 7,
wherein each of the plurality of image forming units comprises the humidity detection unit, and
wherein, based on the detection result from the humidity detection unit included in each of the plurality of image forming units, the control unit causes the image forming units to form the detection toner pattern under different formation conditions on the first humidity or the second humidity.

9. An image forming apparatus comprising:
first and second image forming units each configured to form a toner image on an image bearing member;
a detection unit configured to detect a relative position of the toner image formed on the image bearing member by the first image forming unit with respect to the toner image formed on the image bearing member by the second image forming unit; and
a control unit configured to cause the first image forming unit to form a detection toner pattern on the image bearing member for detecting the relative position,
wherein the control unit causes the first image forming unit to form the detection toner pattern under different formation conditions on a first humidity or a second humidity lower than the first humidity in such a manner that a density of the detection toner pattern formed at the first humidity is higher than a density of the detection toner pattern formed at the second humidity.

10. The image forming apparatus according to claim 9,
wherein the first image forming unit comprises alight source configured to emit a light beam to a photosensitive member based on image data to form the detection toner pattern on the image bearing member, and
wherein the control unit controls emission time of the light beam from the light source in such a manner that the emission time of the light beam to form the detection toner pattern at the first humidity is longer than the emission time of the light beam to form the detection toner pattern at the second humidity.

11. The image forming apparatus according to claim 9,
wherein the first image forming unit comprises alight source configured to emit a light beam to a photosensitive member based on image data to form the detection toner pattern on the image bearing member, and
wherein the control unit controls light quantity of the light beam in such a manner that the light quantity of the light beam to form the detection toner pattern at the first humidity is larger than an emission time of the light beam to form the detection toner pattern at the second humidity.

12. The image forming apparatus according to claim 9,
wherein the first image forming unit comprises a developing unit configured to form a toner image on the image bearing member with a developer including toner and carrier which charges the toner.

13. The image forming apparatus according to claim 9, further comprising:
a humidity detection unit configured to detect the humidity,
wherein the humidity detection unit detects a relative humidity.

14. The image forming apparatus according to claim 13 further comprising:
a temperature detection unit,
wherein the control unit calculates a moisture content per unit volume based on a relative humidity detected by the humidity detection unit and a temperature detected by the temperature detection unit, and
wherein the control unit causes the first image forming unit to form the detection toner pattern under different formation conditions on a first moisture content and a second moisture content lower than the first moisture content in such a manner that the density of the detection toner pattern formed at the first moisture content is higher than the density of the detection toner pattern formed at the second moisture content.

15. The image forming apparatus according to claim 9, further comprising:
at least one humidity detection unit configured to detect the humidity,
wherein, based on a detection result of the humidity detection unit, the control unit causes the first image forming unit to form the detection toner pattern under different formation conditions on the first humidity or the second humidity.

16. The image forming apparatus according to claim 15,
wherein the first image forming unit comprises the humidity detection unit, and
wherein, based on the detection result from the humidity detection unit included in the first image forming unit, the control unit causes the first image forming unit to form the detection toner pattern under different formation conditions on the first humidity or the second humidity.
